(19) United States
(12) Patent Application Publication
(10) Pub. No.: US 2013/0080147 A1
(43) Pub. Date: Mar. 28, 2013

(54) METHOD OF INTERACTION OF VIRTUAL FACIAL GESTURES WITH MESSAGE

(71) Applicant: Vladimir Vitalievich Miroshnichenko, Ljubertsi (RU)

(72) Inventor: Vladimir Vitalievich Miroshnichenko, Ljubertsi (RU)

(21) Appl. No.: 13/699,508

(22) PCT Filed: Jun. 16, 2011
(86) PCT No.: PCT/RU2011/000422

§ 371 Date: Nov. 21, 2012

(30) Foreign Application Priority Data
Jun. 17, 2010 (RU) 2010124351

(51) Int. Cl. G06F 17/28; G06T 19/00; G06T 13/00

(52) U.S. Cl. CPC G06F 17/289; G06T 13/00; G06T 19/00
USPC 704/3; 345/473; 345/419

(57) ABSTRACT

It is claimed the method of interaction of virtual facial gestures with message wherein at replacing voice message (hereinafter referred to as VM1) which is pronounced or has been pronounced by displayed person on fully or partially another voice message (hereinafter referred to as VM2) instead of displaying part of face of specified person or part of face of specified person and at least one subject and/or at least one part of at least one subject from subjects, wholly or partially located on the face of specified person virtual facial gestures, which correspond to facial gestures at pronouncing VM2, are displayed.

### CROSS-REFERENCE TO RELATED APPLICATIONS

This application is a U.S. national stage application of a PCT application PCT/RU2011/000422 filed on 16 Jun. 2011, published as WO 2011/159204, whose disclosure is incorporated herein in its entirety by reference, which PCT application claims priority of a Russian Federation application RU2010124351 filed on 17 Jun. 2010.

### FIELD OF THE INVENTION

Present invention relates to the electronic technology and can be used to improve quality of communication between people, who speak different languages or using different languages, at using video communication technical means.

### BACKGROUND OF THE INVENTION

It is known synchronization of virtual facial gestures with person speech. Mentioned technology allows creating synchronous voice facial gestures by converting the audio stream in the facial animation. More detailed information is available at http://speechanimator.ru/.

The disadvantage of specified technical solution is that it does not provide ability to replace facial gestures of displayed person at pronouncing voice message to virtual facial gestures corresponding to another voice message, including the voice message, which is translation into other language of voice message pronounced by displayed person. The disadvantage of mentioned technical solution is the said decision does not provide displaying the head of a real person with virtual facial gestures on the face of mentioned person.

Author of the invention was unable to find in public information sources analogues (prototypes) of present invention.

### DESCRIPTION OF THE INVENTION

The task to be solved by the claimed technical solution is to improve quality of communication between people, who speak different languages or using different languages, at using video communication technical means.

The technical result: at replacing voice message which is pronounced or has been pronounced by displayed person on fully or partially another voice message facial gestures of displayed person correspond to specified fully or partially another voice message. With a view of correct understanding and interpretation of used in present group of five inventions terms the following terminology has been used:

Virtual facial gestures are facial gestures, which are displayed in the form of at least one virtual object. In this case, multimedia objects also refer to virtual objects. Virtual facial gestures are using in music videos, movies, etc. Virtual facial gestures are displayed instead of displaying part of face or facial gestures of displayed person, or other living being, or other virtual image (for example, an image in form of a person). When virtual facial gestures are displayed, real or part of real facial gestures of person can be displayed in background, that is, in such a way that it is slightly visible on the display. Correspondance of virtual facial gestures to a person voice message is that the movement of virtual images of lips, facial muscles and other parts of human face within the virtual facial gestures correspond approximately to those movements of specified parts of the face of person which specified person would have, if itself said specified voice message. In the context of the present invention virtual facial gestures can permanently, or temporarily, or periodically, in whole or in part, include virtual images of human face parts, which are not involved in gestures. In the context of present invention, virtual facial gestures can permanently, or temporarily, or periodically include a virtual image of at least one subject and/or at least one part of at least one subject.

Virtual gesticulations are gesticulations, which are displayed in the form of at least one virtual object. In this case, multimedia objects also refer to virtual objects. Virtual gesticulations are using in music videos, movies, etc. Virtual gesticulations are displayed instead of at least one part of body. In this case, when virtual gesticulations are displayed, real or part of real gesticulations of person can be displayed in background. Virtual gesticulations can permanently, or temporarily, or periodically include a virtual image of at least one subject and/or at least one part of at least one subject.

Virtual images are displayed images, which are images of existing or non-existing people, existing or non-existing animals, existing or non-existing other living beings.

Parameters of human face are parameters of human face, which include:
color of skin or color of at least one part of face,
facial structure,
eyes, tongue, gums, throat, nose, ears, cheeks, forehead, chin,
shape, size of face or of at least one part of face,
characteristics of facial skin integument, including presence or absence of stains, sweat, moles, mustache, beard, bristle, hair, scars, wrinkles, burns, as well as their configuration, size, color and location on the face.
characteristics of motion of at least one of facial muscles, at pronunciation of voice message or single sound, or word,
configuration and size of facial muscles,
type, structure, shape, size, color, location of at least one tooth
symptoms of disease on face (furunculus, acne, etc.)
other known parameters of human face.

Parameters of human body are parameters of human body, which include:
color of skin,
color of individual body parts,
structure of body or of at least one part of it,
shape, size of body or of at least one part of body,
characteristics of body skin integument, including presence or absence of stains, sweat, moles, scars, wrinkles, burns on body skin integument, as well as their configuration, size, color,
characteristics of motion of at least one of body muscles,
configuration, size of body muscles,
other known parameters of human body.
The specified technical result according to the first invention is achieved as follows:

At replacing voice message (hereinafter referred to as VM1) which is pronounced or has been pronounced by displayed person on fully or partially another voice message (hereinafter referred to as VM2) instead of displaying part of face of specified person or part of face of specified person and at least one subject and/or at least one part of at least one subject from subjects, wholly or partially located on the face of specified person, virtual facial gestures, which correspond to facial gestures at pronouncing VM2, are displayed.

VM2 can be a translation of VM1, including simultaneous translation of VM1 from one speech language to another speech language.

VM2 can be pronounced after pronouncing VM1, or VM2 can be pronounced partially during pronunciation of VM1 and partially after pronunciation of VM1, or VM2 can be pronounced during pronunciation of VM1.

In virtual facial gestures of displayed person who is pronouncing or has pronounced VM1, permanently or temporarily or periodically can be considered:

a) at least one face parameter of a person who is pronouncing or has pronounced VM1, and/or
b) at least one parameter of specified person facial gestures, and/or
c) weather conditions or at least one of parameters of weather conditions under which displayed face or displayed a part of specified person face is situated, and/or
d) illumination or at least one of parameters of illumination of face or part of face of specified person, when it is displayed, and/or
e) illumination or at least one of parameters of illumination of at least one subject and/or at least one part of at least one subject from subjects, wholly or partially located on face of specified person, when it is displayed, and/or
f) at least one subject and/or at least one part of at least one subject from subjects, wholly or partially located on face of specified person, and/or
g) at least one parameter of at least one subject from subjects fully or partially located on face of specified person, and/or
h) at least one subject and/or at least one part of at least one subject from subjects that specified person uses to wear on face or to hide face or part of face, and/or
i) at least one parameter of at least one subject and/or at least one part of at least one subject from subjects that specified person uses to wear on face or to hide face or part of face.

At pronouncing VM1 or VM2 can be additionally displayed person who is pronouncing or has pronounced VM1, and/or at another display can be in addition displayed person who is pronouncing or has pronounced VM1, herewith, to specified additionally displayed person and/or to specified person displayed at another display virtual facial gestures are not applied.

On display can be set designation indicating at what speech language VM2 is pronounced and/or at what speech language VM1 is pronounced or has been pronounced, and/or VM1 and/or VM2 are displayed as a text.

As compared to VM1 VM2 can be pronounced in whole or in part with different rate and/or with different volume and/or with different length of words and/or with different emotional and/or with different diction and/or with different intonation and/or with different emphasis, and/or with other known features of pronouncing voice messages.

As compared to VM1 VM2 can be sounded fully or partially in a song mode.

At pronouncing VM2 instead of displaying at least one part of a body of specified person who is pronouncing or has pronounced VM1 virtual gesticulation can be displayed, herewith, specified part of a body is at least one arm and/or at least one part of at least one arm of specified person and/or at least one another part of a body of specified person.

In virtual gesticulations of displayed person who is pronouncing or has pronounced VM1 permanently or temporarily or periodically can be considered:

a) at least one parameter of body, and/or
b) at least one parameter of at least one part of body of specified person, and/or
c) at least one subject and/or at least one part of at least one subject from subjects located on body, or on part of body, or near body, or part of body of specified person, and/or
c) at least one subject and/or at least one part of at least one subject from subjects which specified person uses for location on body, or on part of body, or near body, or part of body of specified person, and/or
d) weather conditions or at least one of parameters of weather conditions under which displayed specified person and/or displayed part of specified person is situated, and/or
e) illumination or at least one of parameters of illumination of specified person and/or part of specified person, when it is displayed, and/or
f) illumination or at least one of parameters of illumination of at least one subject and/or at least one part of at least one subject from subjects, located on body, or on part of body, or near body, or part of specified person body, when it is displayed.

Display user and/or electronic device software that is connected to display and/or user of at least one another electronic device that is connected to specified display and/or to device, by which specified display is controlled, and/or software of electronic device connected to specified display and/or to device, by which specified display is controlled, and/or displayed person and has access to at least one electronic device that is connected to specified display and/or to device, by which specified display is controlled, can set:

a) voice timbre and/or other well-known voice parameters that are used at pronouncing VM2, and/or
b) beginning and/or ending VM2 pronouncing, and/or
c) at least one parameter of displaying virtual facial gestures of specified person, and/or
d) beginning and/or ending displaying virtual facial gestures of specified person, and/or
e) at least one parameter of displaying virtual gesticulations of specified person, and/or
f) beginning and/or ending displaying virtual gesticulations of specified person, and/or
g) at least one parameter of at least one displaying specified person, and/or
h) location and/or size of displaying or locations and/or sizes of displaying specified person, and/or
i) on which of specified persons displaying virtual facial gestures and/or virtual gesticulations are applied and/or
j) beginning and/or ending VM1 pronouncing, and/or
k) at least one displayed gesture or a list of specified person gestures that are replaced by virtual gestures.

Display user and/or electronic device software that is connected to display and/or user of at least one another electronic device that is connected to specified display and/or to device, by which specified display is controlled, and/or software of electronic device connected to specified display and/or to device, by which specified display is controlled, and/or displayed person and has access to at least one electronic device that is connected to specified display and/or to device, by which specified display is controlled, can set: a) beginning and/or ending displaying VM 1 text and/or VM 2 text, and/or b) at least one parameter of displaying VM 1 voice message text and/or VM 2 voice message text.

If person image displayed is three-dimensional (3D), virtual facial gestures and/or virtual gesticulations of displayed person can be also three-dimensional (3D).

### EMBODIMENT OF THE INVENTION

Hardware, software, components and materials, which are known in the background art, allow implementing claimed method of interaction of virtual facial gestures with message.

### APPLICATION OF THE INVENTION

Claimed technical solution can be applied in improving quality of communication between people, who speak different languages or using different languages, at using video communication technical means.

1. A method of interaction of virtual facial gestures with message wherein at replacing voice message (hereinafter referred to as VM1) which is pronounced or has been pronounced by displayed person on fully or partially another voice message (hereinafter referred to as VM2) instead of displaying part of face of specified person or part of face of specified person and at least one subject and/or at least one part of at least one subject from subjects, wholly or partially located on the face of specified person, virtual facial gestures, which correspond to facial gestures at pronouncing VM2, are displayed.

2. The method according to claim 1, wherein VM2 is a translation of VM1 from one speech language to another speech language.

3. The method according to claim 1, wherein VM2 is pronounced after pronouncing VM1 or VM2 is pronounced partially during pronunciation of VM1 and partially after pronunciation of VM1, or VM2 is pronounced during pronunciation of VM1.

4. The method according to claim 1, wherein in virtual facial gestures of displayed person who is pronouncing or has pronounced VM1, permanently or temporarily or periodically are considered:
a) at least one face parameter of a person who is pronouncing or has pronounced VM1, and/or
b) at least one parameter of specified person facial gestures, and/or
c) weather conditions or at least one of parameters of weather conditions under which displayed face or displayed a part of specified person face is situated, and/or
d) illumination or at least one of parameters of illumination of face or part of face of specified person, when it is displayed, and/or
e) illumination or at least one of parameters of illumination of at least one subject and/or at least one part of at least one subject from subjects, wholly or partially located on face of specified person, when it is displayed, and/or
f) at least one subject and/or at least one part of at least one subject from subjects, wholly or partially located on face of specified person, and/or
g) at least one parameter of at least one subject from subjects fully or partially located on face of specified person, and/or
h) at least one subject and/or at least one part of at least one subject from subjects that specified person uses to wear on face or to hide face or part of face, and/or
i) at least one parameter of at least one subject and/or at least one part of at least one subject from subjects that specified person uses to wear on face or to hide face or part of face.

5. The method according to claim 1, wherein at pronouncing VM 1 or VM 2: a) are additionally displayed person who is pronouncing or has pronounced VM 1, and/or b) at another display are in addition displayed person who is pronouncing or has pronounced VM 1, herewith to specified additionally displayed person and/or to specified person displayed at another display virtual facial gestures are not applied.

6. The method according to claim 1, wherein on display is set designation indicating at what speech language VM2 is pronounced and/or at what speech language VM1 is pronounced or has been pronounced.

7. The method according to claim 1, wherein VM1 and/or VM2 are displayed as a text.

8. The method according to claim 1, wherein as compared to VM1 VM2 is pronounced in whole or in part with different rate and/or with different volume and/or with different length of words and/or with different emotional and/or with different diction and/or with different intonation and/or with different emphasis, and/or with other known features of pronouncing voice messages.

9. The method according to claim 1, wherein as compared to VM1 VM2 is sounded fully or partially in a song mode.

10. The method according to claim 1, wherein at pronouncing VM2 instead of displaying at least one part of a body of specified person who is pronouncing or has pronounced VM1 virtual gesticulation is displayed, herewith, specified part of a body is at least one arm and/or at least one part of at least one arm of specified person and/or at least one another part of a body of specified person.

11. The method according to claim 1, wherein in virtual gesticulations of displayed person who is pronouncing or has pronounced VM1 permanently or temporarily or periodically are considered:
a) at least one parameter of body, and/or
b) at least one parameter of at least one part of body of specified person, and/or
c) at least one subject and/or at least one part of at least one subject from subjects located on body, or on part of body, or near body, or part of body of specified person, and/or
c) at least one subject and/or at least one part of at least one subject from subjects which specified person uses for location on body, or on part of body, or near body, or part of body of specified person, and/or
d) weather conditions or at least one of parameters of weather conditions, under which displayed specified person and/or displayed part of specified person is situated, and/or
e) illumination or at least one of parameters of illumination of specified person and/or part of specified person, when it is displayed, and/or
f) illumination or at least one of parameters of illumination of at least one subject and/or at least one part of at least one subject from subjects, located on body, or on part of body, or near body, or part of specified person body, when it is displayed.

12. The method according to claim 1, wherein are set:
a) voice timbre and/or other well-known voice parameters that are used at pronouncing VM2, and/or
b) beginning and/or ending VM2 pronouncing, and/or
c) at least one parameter of displaying virtual facial gestures of specified person, and/or
d) beginning and/or ending displaying virtual facial gestures of specified person, and/or
e) at least one parameter of displaying virtual gesticulations of specified person, and/or
f) beginning and/or ending displaying virtual gesticulations of specified person, and/or
g) at least one parameter of at least one displaying specified person, and/or
h) location and/or size of displaying or locations and/or sizes of displaying specified person, and/or
i) on which of specified persons displaying virtual facial gestures and/or virtual gesticulations are applied and/or
j) beginning and/or ending VM1 pronouncing, and/or
k) at least one displayed gesture or a list of specified person gestures that are replaced by virtual gestures.

13. The method according to claim 1, wherein are set: a) beginning and/or ending displaying VM 1 text and/or VM 2 text, and/or b) at least one parameter of displaying VM 1 voice message text and/or VM 2 voice message text.

14. The method according to claim 1, wherein if person image displayed is three-dimensional (3D), virtual facial gestures and/or virtual gesticulations of displayed person are also three-dimensional (3D).

15-65. (canceled)
